(19) United States
(12) Patent Application Publication
(10) Pub. No.: US 2024/0351366 A1
(43) Pub. Date: Oct. 24, 2024

(54) Method and Device for Applying a Decoration and a Surface Structure to a Carrier Material

(71) Applicant: Flooring Technologies Ltd., Kalkara (MT)

(72) Inventors: Norbert Kalwa, Horn-Bad Meinberg (DE); Georg Seidack, Wittstock / Dosse (DE); Torsten Kopp, Ruhner Berge (DE)

(21) Appl. No.: 18/682,314

(22) PCT Filed: Aug. 9, 2022
(86) PCT No.: PCT/EP2022/072329

§ 371 Date: Feb. 8, 2024

(30) Foreign Application Priority Data
Aug. 9, 2021 (EP) 21190337.2

(51) Int. Cl. B44C 1/24; B44C 3/02; B44C 5/04

(52) U.S. Cl. CPC B44C 1/24; B44C 3/025; B44C 5/043

(57) ABSTRACT

The invention relates to a method for applying a decoration and a surface structure to a carrier material and to a device which is suitable for this. According to the method, a carrier material or at least one decorative paper is printed with a decoration and a file for the surface structure is created from the digital image data of the decoration. Furthermore, at least one layer of resin is applied to the printed carrier material or to at least one overlay. The distribution of the resin is predetermined by the file for the surface structure and is therefore dependent on the printed decoration. At least one resin layer is then pressed with the carrier material using a structured press plate, or at least one overlay, at least one decorative paper and a carrier material are pressed using a structured press plate. In both cases, the structure of the press plate is predetermined by the digital data in the file for the surface structure and is therefore also dependent on the printed decoration. Using the method according to the invention, a surface structure is formed on the carrier material that is synchronous with the applied decoration.

### CROSS REFERENCE TO RELATED APPLICATIONS

This application is the United States national phase of International Patent Application No. PCT/EP2022/072329 filed Aug. 9, 2022, and claims priority to European Patent Application No. 21190337.2 filed Aug. 9, 2021, the disclosures of which are hereby incorporated by reference in their entireties.

### BACKGROUND OF THE INVENTION

### Field of the Invention

The invention relates to a method for applying a decoration and a surface structure to a carrier material, and to an apparatus suitable therefor. In the method, a carrier material or at least one decorative paper is printed with a decoration, and a file for the surface structure is produced from the digital image data of the decoration. Additionally, at least one layer of a resin is applied to the printed carrier material or to at least one overlay, the distribution of the resin being dictated by the file for the surface structure and thus being dependent on the imprinted decoration. Subsequently, the at least one resin layer is pressed with the carrier material using a structured press platen, or the at least one overlay, the at least one decorative paper and a carrier material are pressed using a structured press platen. In both cases, the structure of the press platen is dictated by the file for the surface structure and is thus likewise dependent on the printed decoration. With the method of the invention, a surface structure is formed on the carrier material that is synchronous to the applied decoration.

### Description of Related Art

The use of wood-based material boards or wood-plastic composite (WPC) boards in the furniture industry, as floor coverings, tabletops or else for cladding walls and ceilings, requires the surface of the wood-based material boards or wood-plastic composite boards to be machined/enhanced. In the case of the stated fields of use, the wood-based material boards are typically coated with an impregnated decorative paper. To increase the wear resistance, an overlay is applied to the decorative paper. Overlays used are thin papers typically having been impregnated with a melamine resin. In addition, abrasion-resistant particles, such as corundum particles, for example, may have been incorporated into the resin of the overlay by mixing, to increase the abrasion resistance of the wood-based material boards or wood-plastic composite boards.

Alternatively, the wood-based material boards or wood-plastic composite boards may also be printed directly with a decoration. Typically, a plurality of liquid, heat-curable resin layers (typically melamine resins) are e subsequently applied to the decoration applied by direct printing, and these resin layers may in turn contain abrasion-resistant particles for increasing the wear resistance.

In the production of wood-based material boards or wood-plastic composite boards with melamine resin coating, a key quality feature is the pleasing surface structuring. This structuring not only ought to be synchronous to the decoration, but also, in relation to the structure depths of the structure of the decoration, ought to be a highly precise imitation of the original from nature or from another product. The primary consideration is therefore for the copy to give a visual and tactile impression that is extremely true to the original. Hence it is desirable that the impressed structure is harmonized with the imprinted decoration and so forms a decoration-synchronous structure or else a synchropore.

To date, wood reproduction has frequently been at the center point of end consumer interest. To achieve an outcome that is extremely true to nature, the wood-based materials have been given simple pore structures during production. The structure depth range here has usually been below 100 μm, and frequently indeed below 50 μm.

For specific applications such as tabletops in offices, indeed, flat structures (tub structure) have been prescribed.

Through the advent of digital printing, a wide variety of different forms of material reproduction have now come to be of interest to the end consumer. Among others, for example, stone decorations, fantasy decorations or inlay decorations have come into the spotlight. As a result of the new decorative demands and new products (elastic floorcoverings), structures of greater and greater depth are now being asked for. In many cases these are also extensive impression systems, of the kind which are the order of the day for imitation tiles, highly structured woods or inlays, for example.

For melamine resin-coated products in the floorcovering sector, there is a problem which arises here from the prior art, since these structured systems in some cases go well above a structure depth of 100 μm. Firstly, for these laminate products, it is almost exclusively HDF (high-density fiberboard) which is used, with envelope densities of more than 800 and in some cases more than 900 kg/m³. These products cannot be structured without considerable cost and complexity (very high pressure), something not possible on many short-cycle presses (SC presses) of older construction. Such presses are able to press at a maximum of 50 kg/cm², which for structured systems with a structure depth of greater than 200 μm is not sufficient. Secondly, either an impregnation construct (resinated overlay paper and printed and resinated decorative paper) or direct printing on a color undercoat is employed on the top side. With deep structuring, these layers may rupture and then lead to laminate products of less than 100% quality.

It has emerged, moreover, that if platens with deep structuring are used, i.e., press platens with structure depths of around 600 μm, presses with pressing pressures above 50 kg/cm² and prolonged pressing times (>20 sec) first cause compression of the construct, meaning that a corresponding structure is also impressed. After the pressing, however, this compression and hence the resultant structuring are lost again to a large extent owing to what is called the “spring back” effect. The compressed materials expand again and the compression becomes less dense or compact.

There are therefore decisive disadvantages:
structuring with structure depths of more than 200 μm is extremely difficult;
in certain circumstances, capital investment must be made in order to acquire presses with higher pressing pressures;
100% quality cannot be guaranteed.

The known prior art on the application of surface structures includes, for example, EP 3 738 787 A1. While the latter does describe the application of resin layers in powder form to printed wood-based material boards, as already observed, the application of these resin layers is unable to form structures having a depth of more than 200 μm.

EP 2 913 199 B1 is concerned with the construction of tactile structures by 3D printing. This process is exceedingly time-consuming and cannot be employed for the production of high piece numbers in a short time. The means of choice in the rapid production of printed wood-based materials or printed wood-plastic composite materials are production processes with at least one SC press. A 3D printing process, however, cannot be employed rationally and efficiently in such a press. The process is therefore uneconomic and suitable at best only for small piece numbers or for the production of prototypes.

DE 10 2009 044 802 A1 discloses a process in which a surface structure is constructed through the application of different-sized varnish droplets. To construct deep structures, it is necessary to apply multiple layers of varnish droplets in succession, with each layer first needing to be at least incipiently dried/cured before a further layer is applied. The process is therefore capable of generating structures having a depth of between 1 μm and 3 mm, which may also be configured as synchropores. Nevertheless, the process has a number of disadvantages:
a varnish layer must be dried/incipiently cured within an extremely short time in order to prevent the droplets running;
the properties of the varnishes used must be precisely controlled and known (viscosity, thixotropy);
varnish is a very price-intensive raw material, to the detriment of production profitability;
the process cannot be integrated into the usual existing production operations. Similarly to the application of the structure by 3D printing, the application of the varnish structure cannot be done in a production process with at least one SC press. This prolongs production time, to the massive detriment of the process profitability.

US 2014/023832 A1 utilizes a curable ink pattern or cured ink matrix in order to form depressions in an overlay. The cured ink matrix is subsequently removed from the carrier material. The structure is therefore formed in the overlay and, in certain circumstances, in the carrier material. The ink matrix does not remain in the layer system and so serves only as a means of generating a depression in the overlay and possibly in the carrier material. In this way, while tactile structures can be generated, the ink matrix must first be generated and applied in a first operation, and removed again in a further operation. This makes the process inconvenient and uneconomic.

Another known document is EP 2 036 741 A2. It discloses a process in which a decoration is generated on a carrier material using a color decoration roll, and subsequently a UV-curing colorless matt varnish is applied partially, by means of a structured varnish application roll, the structuring of the roll at least partly matching the pore structure dictated by the decoration. A structured varnish application roll is understood to be a roll having a surface which applies varnish only in sections in order, for example, to produce visual pores. In a further step, an embossing roll can be used to impress depressions corresponding to scratches or abrasion tracks. The aim is that differences in reflection characteristics create the impression of depressions in the surface and so render imitation pores more realistic. Varnish application in accordance with EP 2 036 741 A2 using the structured varnish application roll is intended to produce a visual impression of a structure, but not to generate a tactile structure.

### SUMMARY OF THE INVENTION

The object on which the present invention is based is therefore that of eliminating the disadvantages from the prior art and providing a method that allows decoration-synchronous structures of diverse decorations to be applied on a sequential line with at least one pressing means to a wood-based material or a wood-plastic composite.

For this, the invention provides a method as described herein for applying a decoration and a surface structure to a carrier material.

In addition, the present invention embraces an apparatus as described herein for applying a decoration and a surface structure to a carrier material by the method of the invention.

In the invention, a carrier material or a carrier material, at least one decorative paper and at least one overlay is or are provided.

In one method step of the method of the invention, the carrier material or at least one decorative paper is printed with a decoration. The decoration is preferably in digital form. Alternatively, an analog decoration must be converted into a digital decoration. Possibilities for this, such as photographing the decoration with a digital camera, scanning it in with a color scanner, or scanning it using a hyperspectral scanner, for example, are known from the prior art.

The decoration is printed in a direct printing process onto the carrier material or at least one decorative paper. Direct printing processes used are, in particular, gravure and digital printing processes. The gravure process is a printing technique in which the elements for imaging take the form of depressions in a printing form which is inked ahead of printing. The printing ink is located primarily in the depressions and is transferred to the print substrate, a carrier material for example, by contact pressure of the printing form and by adhesion forces. Where indirect gravure printing is used, a plurality of printing rolls are employed.

In one preferred embodiment of the present invention, the decoration is printed onto the carrier material or at least one decorative paper via digital printing processes. With digital printing, the print image (decoration) is transferred directly from a computer into a printing machine, such as a laser printer or inkjet printer, for example. There is no need in this case to use a static printing form. Decorative printing according to the inkjet principle takes place in a single pass in which the entire width of the top side to be printed is traversed, with the carrier material or the at least one decorative paper being conveyed beneath the printer. Alternatively, it is possible for the carrier material for printing or the at least one decorative paper to be held beneath the printer and for the latter to run over the surface at least once during printing. A particular advantage when using a digital printing process for printing the carrier material or the at least one decorative paper is that the decoration is already in digital form.

According to the present invention, the carrier material is selected from the group containing wood-based material boards, more particularly medium-density fiberboard (MDF), high-density fiberboard (HDF), chipboard, oriented-strand board (OSB), plywood boards and wood-plastic composite (WPC) boards.

In one embodiment of the present invention, an undercoat is applied to the carrier material before the printing or before the application of at least one decorative paper. For this, the carrier material may be provided, for example, by an undercoat layer composed of a resin and/or a varnish. For undercoating here, an aqueous resin solution and/or a radiation-curable filling compound may be applied to the side of the carrier material that is to be printed or that faces the decorative paper. Undercoat materials that can be used are, for example, aqueous, formaldehyde-containing resin solutions such as melamine-formaldehyde resins, urea-formaldehyde resin or melamine-urea-formaldehyde resin. It is likewise possible to undercoat the carrier material with UV filler and/or EBC filler in advance and then to cure the undercoat layer correspondingly. The undercoats may of course also contain pigments.

Additionally, in one embodiment, abrasion-resistant particles and/or glass beads may be applied to the undercoat. Abrasion-resistant particles in this case may be selected from a group containing corundum (aluminum oxides), boron carbides, silicon dioxides, silicon carbides and silanized corundum particles. Applying abrasion-resistant particles and/or glass beads allows the wear resistance of a carrier material provided with a decoration and a structure to be increased.

The undercoat, furthermore, may contain at least one additive and/or at least one adjuvant. Suitable additives are selected from the group containing curing agents, wetting agents (surfactants or mixtures thereof) and release agents. Suitable adjuvants are selected from the group containing conductive substances and cellulose. The conductive substances may be selected from the group containing carbon black, carbon fibers, metal powders and nanoparticles, especially carbon nanotubes.

In a further embodiment of the present invention, a primer layer is applied to the undercoat, preferably as a single application with subsequent drying. In the case of a subsequent gravure process (with rolls) in particular, the primer layer is useful, whereas it is not absolutely necessary if employing a digital printing process. Primers used are preferably polyurethane-based compounds.

In the invention, a file for the surface structure is produced from the digital image data of the decoration. This is done by suitable computer software. The file for the surface structure contains the digital data of the surface structure of the decoration and hence a structure depth assigned for each image point of the decoration.

Where the decoration is already present digitally, in one embodiment the decoration data for the individual color channels can be separated from the digital data of the decoration using software such as, for example, PhotoShop, Paint or PaintShop Pro. The digital data of the color channels in turn contain information regarding the surface structure. The color channel containing, for example, the information regarding “wood grain”, i.e., dark hues, would in that case indicate reduced resin application or none at all. Each color channel therefore contains information regarding the structure depth of a defined image point in the decoration. In the end product, a wood grain pore is then configured as a depression on the surface. The digital data of the color channels therefore contain the information regarding the surface structure and may thus serve as digital data of the surface structure. In one embodiment of the present invention, accordingly, the digital data of the surface structure of the decoration are contained in the file for the surface structure in the form of the digital data of the color channels.

In one embodiment of the present invention, the digital image data of the decoration are produced by scanning-in an analogous decoration original. In this case, the file for the surface structure may in one embodiment be generated directly from the digital data of the scanner. Known from the prior art here are scanners which compile 2D data or data from different lighting situations and use them to compute digital data for the surface structure of the scanned-in decoration. Suitable scanners for this purpose are provided, for example, by METIS Systems S.r.l. and by Cruse Spezialmaschinen GmbH. In this embodiment, therefore, the digital data of the surface structure of the decoration are contained in the file for the surface structure, in the form of the digital data of the surface structure as provided by a suitable scanner.

Alternatively, the scanned digital data may also be used for separating the decoration data for the individual color channels by means of software such as, for example, PhotoShop, Paint or PaintShop Pro. This approach has already been comprehensively described.

In a subsequent method step, at least one layer of resin is applied to the printed carrier material or to at least one overlay, the distribution of the resin being dictated by the digital data of the file for the surface structure and thus being dependent on the imprinted decoration.

The determination of which regions of the carrier material or of the overlay receive which amount of resin applied per unit area is dictated in the invention by the digital data of the file for the surface structure. Since the file for the surface structure contains the surface structure of the decoration in digital form and hence a structure depth assigned for each image point of the decoration, the amount of application of the at least one resin layer is matched precisely to the decoration. In regions in which, later on, there are to be elevations in the carrier material provided with the decoration, a greater amount of resin per unit area is applied than in regions with flatter structures or no structure.

In one embodiment, multiple layers of resin are applied to the printed carrier material or to the overlay. Between 2 and 6 layers of resin, preferably between 2 and 5 layers of resin, more preferably between 2 and 4 layers of resin may be applied. The application of multiple layers may be necessary, for example, if application quantities cannot be realized in one pass. Multiple layers of resin may also be applied only in the regions in which a greater amount of resin per unit area is to be applied by comparison with surrounding regions.

In one embodiment, after the application of the at least one resin layer, it may be incipiently dried or set. This prevents the resin layer running. Where multiple layers of resin are applied, it may be incipiently dried after the application of each layer.

The resin of the at least one resin layer may be applied as pulverulent resin and/or as liquid resin. Where resin powder rather than liquid resin is used, there is no need to incipiently dry the at least one and each further resin layer. This reduces plant costs, air extraction issues and footprint in the production plant. Suitable pulverulent resins have a particle size of between 20 to 100 μm, preferably between 40 and 89 μm. A pulverulent resin may be applied, for example, by way of a digital printer. The digital printer, specifically the amount to be applied as a function of location, is controlled in this case by means of the digital data of the file for the surface structure. The resolution of the amount applied is then in line with the resolution of the digital printer. The resolution of the amount applied describes how small adjacent areas with mutually different applied amounts of resin can be. After a layer of a pulverulent resin has been applied, the resin in one embodiment can be set, by an infrared emitter (IR emitter), for example.

Where a liquid resin is used for the at least one resin layer, it preferably has a solids content of more than or equal to 70% by weight. The solids content influences the viscosity of the liquid resin, with running of the resin after application being prevented by a solids content of more than or equal to 70% by weight. In one embodiment of the invention, the liquid resin may additionally be heated, to further increase the viscosity of the resin. In part, however, the heating of the resin does not bring about complete polymerization thereof, allowing further cross-linking or polymerization at a later point in time in processing. A liquid resin may be applied by nozzles, for example. In this case the nozzles, specifically the amount to be applied as a function of location, are/is controlled by means of the digital data of the file for the surface structure. The resolution of the amount applied is then in line with the resolution of the nozzles used. After a liquid resin layer has been applied, it may be incipiently dried with a convection dryer/IR emitter.

Suitable resins are selected from the group containing melamine-formaldehyde resins, phenolic resins, melamine-urea-formaldehyde resins and urea-formaldehyde resins.

The resin may further comprise at least one additive and/or at least one adjuvant. Useful groups of additives and adjuvants prove to be the same as those already described for the undercoat.

The overall applied amount of the at least one resin in the invention is preferably between 100 and 500 g/m² of resin. Here, the corresponding amounts of resin as already described may be applied at once or else in multiple layers.

Where an overlay is used, it may be impregnated before the at least one resin layer is applied. Suitability for the impregnation is possessed by liquid resins having a solids content of preferably below 70% by weight, more preferably below 68% by weight. Suitable resins for the impregnation are selected from the group containing melamine-formaldehyde resins, phenolic resins, melamine-urea-formaldehyde resins and urea-formaldehyde resins. The resin may further comprise at least one additive and/or at least one adjuvant. Useful groups of additives and adjuvants prove to be the same as those already described for the undercoat. Furthermore, abrasion-resistant particles and/or glass beads may additionally be applied to the as yet undried resin during impregnation. Abrasion-resistant particles in this case may be selected from a group containing corundum (aluminum oxides), boron carbides, silicon dioxides, silicon carbides and silanized corundum particles. Applying abrasion-resistant particles and/or glass beads allows the wear resistance of a carrier material provided with a decoration and a structure to be increased.

In a further method step, the at least one resin layer is pressed with the carrier material using a structured press platen, or the at least one overlay, the at least one decorative paper and a carrier material are pressed using a structured press platen. The structure of the press platen is dictated by the digital data of the file for the surface structure.

In the invention, a structured press platen is used whose structure is dictated by the digital data of the file for the surface structure. Since the file for the surface structure contains the surface structure of the decoration in digital form and hence contains a structure depth assigned for each image point of the decoration, this file can be used to precisely dictate the structure of the press platen for the decoration. The structure, for example, may be etched or milled out of the press platen; an alternative possibility is to apply additional layers of material on the press platen. To form a joint structure in the case of a tile decoration, for example, trapezoids or similar bodies may be applied on the press platen in order to form the desired structure. Of course, by press platens produced correspondingly, it is possible to realize all possible geometries, corresponding to structures of ornaments, indicia, branches, pores, simulated usage marks or other decorative structures. In principle, any technique with which the skilled person is familiar can be used in order to provide the press platen with the structure dictated by the digital data of the file for the surface structure.

During the pressing, the press platen then structures the layer construct, with a part of the structure height arising from the application of the at least one resin layer. Accordingly, a structuring is generated on the carrier material that is perceived even at a relatively large viewing distance—for example, when standing upright on a floor covering. This structuring of the carrier material is generated in the at least one resin layer and extends into the carrier material. In this way, structure depths can be developed which are determined by the amount of the at least one resin layer applied and by the structure of the press platen. Where the structures are formed on the carrier material in accordance with the present invention, around 50% of the structuring comes about through the structuring of the carrier material, and 50% through the structuring of the at least one resin layer. In the invention, therefore, at least in portions, a surface structure can be formed with a structure depth of greater than 200 μm, preferably greater than 300 μm, more preferably greater than 400 μm on the carrier material. Consequently, the structures formed with the method of the invention generate not only a visual impression of a structure but also a tactile impression. Structures with such a structure depth have hitherto not been able to be generated with the methods from the prior art either at all, or only at high cost (3D printing, application of varnish layers). In the case of application of varnish layers, it may be pointed out that such varnish layers would have to be applied in multiple strata and/or cured, this being massively labor-intensive and therefore uneconomic. Furthermore, varnishes are much more price-intensive than the resins proposed in the method of the invention. It is not possible, moreover, to generate such structures within a manufacturing line using short-cycle presses (SC presses). These disadvantages are eliminated by the present method, which enables integration into existing manufacturing processes, so increasing cost-efficiency. As a result of integration into existing sequential lines with SC presses, moreover, a high level of sequencing in manufacture is enabled, which brings with it a massive economic advantage.

In accordance with the invention, the layer construct which is pressed may have the following construction:
a) carrier material—optionally at least one undercoat—at least one resin layer
b) carrier material—optionally at least one undercoat—decorative paper printed with decoration—overlay with at least one resin layer

In the layer construct as per point a), the decoration has been printed directly onto the carrier material after the application of an optional undercoat.

In the invention, the surface structure formed on the carrier material is synchronous to the applied decoration. In the invention, before the pressing, the carrier material and the press platen, or the carrier material, the decorative paper and the overlay, are positioned relative to one another such that decoration and structure of the press platen, or decoration, the overlay with the at least one resin layer, and the press platen are congruent with one another, i.e., synchronous. Precise positioning may be accomplished, for example, using marks on carrier material, decorative paper, overlay and press platen by means of a camera system.

Where an overlay is used, it preferably has marks at the edge. In this case, for positioning, the distance between the marks in transverse direction is advantageously determined as well as the distance between the marks in longitudinal direction.

In one preferred embodiment of the present invention, the pressing of the at least one resin layer with the carrier material using a press platen or the pressing of the at least one overlay, the at least one decorative paper and a carrier material using a press platen is carried out in an SC press (short-cycle press). This has the advantage that with the method of the invention, carrier materials can be processed in a high level of sequencing and therefore highly efficiently and economically.

In a further embodiment of the invention, a backing, composed for example of multiple resin layers, or a backing paper, may be applied on the bottom side of the carrier material. This ensures that the tensile forces on the carrier material that arise during pressing by the layers applied on the decoration side and on the bottom side cancel one another out. In the amount of resin applied, the backing applied on the bottom side corresponds approximately to the amount applied on the decoration side, but without the addition of abrasion-resistant particles and/or glass beads.

The present invention further comprises an apparatus for applying a decoration and a surface structure to a carrier material by the method of the invention, comprising
optionally at least one application apparatus for applying at least one undercoat layer;
optionally at least one application apparatus for applying at least one primer layer;
at least one printing apparatus;
at least one camera system;
a means for producing a file for the surface structure from the digital image data of the decoration;
at least one application apparatus for applying the at least one resin layer;
optionally an application apparatus for applying corundum and/or glass beads;
optionally an apparatus for incipiently drying an applied resin layer;
a means for pressing the at least one resin layer with the carrier material or for pressing the overlay and the decorative paper with a carrier material using a structured press platen;
characterized in that the structured press platen has a structure dictated by the digital data of the file for the surface structure.

The features of the method of the invention also apply to the apparatus of the invention, and vice versa.

The application apparatus for applying at least one undercoat layer and optionally at least one primer layer may be a roll mechanism.

The apparatus comprises at least one printing apparatus; suitable printing apparatuses are printing apparatuses for the gravure process and the digital printing process. In the digital printing process, laser printers or inkjet printers are preferably used.

The apparatus further comprises a camera system with which the structured press platen and the carrier material, or the structured press platen, the decorative paper, the overlay and the carrier material, can be positioned relative to one another, by means of marks, in such a way that the carrier material, the press platen and, where present, the overlay and the decorative paper are congruent with one another in terms of structure and decoration.

The means for producing a file for the surface structure, containing the digital data of the surface structure of the decoration, from the digital image data of the decoration is suitably a computing unit; this may be a PC, a tablet or some other terminal unit on which suitable computer software is installed.

The at least one application device for applying the at least one resin layer may, as already described, be a digital printer or an apparatus with nozzles, with the application apparatus comprising a computing unit or being connected to a computing unit which has computer software that controls the amount of the resin applied as a function of the location.

In one embodiment, the apparatus comprises an apparatus for incipiently drying an applied resin layer. Suitable apparatuses are, for example, infrared emitters (IR emitters) or convection dryers.

The apparatus optionally further comprises s an application apparatus for applying corundum and/or glass beads. Suitable application apparatuses for this purpose are, for example, scattering machines. Scattering apparatuses consist substantially of a reservoir hopper, a rotating structured roll, and a scraper. The amount of abrasion-resistant material applied is in this case determined via the rotational speed of the roll. The scattering apparatus preferably comprises a spiked roll.

The apparatus further comprises a means for pressing the at least one resin layer with the carrier material, or for pressing the overlay and the decorative paper with a carrier material, using a structured press platen. With particular preference this means is a short-cycle press (SC press). In accordance with the invention, the structured press platen used in the press apparatus has a structure dictated by the digital data of the file for the surface structure.

By means of the method of the invention and the apparatus of the invention, it is possible to work on existing production lines without capital investment. The interventions in existing and established manufacturing processes here are only marginal. Furthermore, raw materials already present in the production process can be employed. The surface structure is made possible substantially through the application of the at least one resin layer and the utilization of suitably structured press platens.

Suitable resins are available at favorable cost, so boosting the profitability of the method.

### BRIEF DESCRIPTION OF THE DRAWING

The terms Fig., Figs., Figure, and Figures are used interchangeably in the specification to refer to the corresponding figures in the drawings.

The invention is elucidated in greater detail below by 1 figure and 2 exemplary embodiments.

FIG. 1 represents one embodiment of the method in the apparatus of the invention.

### DESCRIPTION OF THE INVENTION

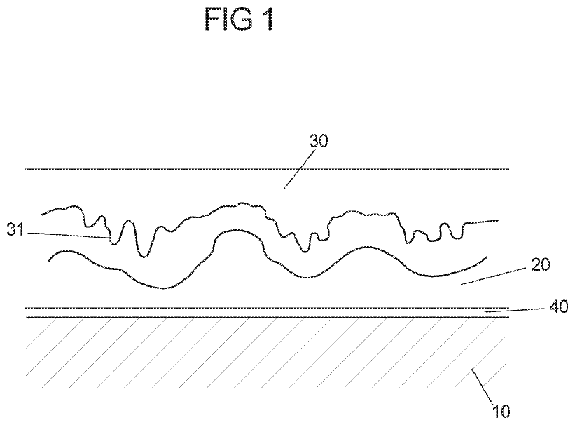

FIG. 1 shows a layer construct in the method of the invention during pressing. Disposed on the carrier element 10 provided with a decorative paper is an overlay 40 with a resin layer 20, whose applied amount varies. Represented above the resin layer 20 is the structured press platen 30, whose structure 31 is aligned congruently with the decoration printed onto the carrier element. Since both the applied amount of the resin layer 20 and the structure 31 of the press platen are matched to the decoration, the resin layer 20 and the structure 31 of the press platen are also matched to one another. This allows surface structures of different depths to be formed during the pressing. The surface structures in the finished pressed layer construct are then synchronous to the decoration of the layer construct.

### Exemplary Embodiment 1

An 8 mm HDF board printed by digital printing on the top side with a tile decoration (with printed cement joint) and provided with a melamine resin coat (around 20 g of resin solids/m2) to protect the print, was introduced onto a production line. Using a roll applicator, first around 60 g of liquid melamine resin per m2 with a solids content of around 60% by weight were applied. The melamine resin contained the customary auxiliaries such as curing agents and wetting agents. Scattered onto/into the resin in succession, using scattering machines, were around 12 g of corundum/m² (F200) and 18 g of glass beads/m². The glass beads had a particle size range of 80-110 μm. The melamine resin was allowed to evaporate over a section of 10 m.

Thereafter, using four further roll applicators, 30 g in each case of liquid melamine resin per m² with a solids content of around 65% by weight were applied. An application of melamine resin in the same amount also took place on the rear side of the HDF board, as a backing. After each application, respective hot air/convection drying took place.

In this way, three HDF boards were prepared. Subsequently, in a last application using a nozzle bar, a thickened melamine resin having a solids content of 70% by weight was applied to two HDF boards. An amount of 150 g/m² was applied to one of the HDF boards in the regions of the tile printing, but not in the regions of the cement joint printing. An amount of 285 g/m² was applied to the second HDF board in the regions of the tile printing, but not in the regions of the cement joint printing. The information for controlling the nozzles came in each case from the digital printing data for the decorative print. The resin was subsequently dried using an IR emitter in each case, so that the moisture content of the resin was around 8% by weight. Subsequently, all three HDF boards were pressed in a short-cycle press at around 200° C. pressing temperature, 50 kg/cm² pressing pressure and 20 sec pressing time, with the boards to be pressed being positioned relative to the structured press platen by means of a camera system, so that board and press platen were aligned to one another.

In the regions containing the cement joints in the decoration, the chromium-plated press platen possessed trapezoidal elevations projecting around 500 μm above the platen surface. These trapezoidal elevations (longitudinal and transverse) imaged the cement joint in the print on the press platen. At the points at which there were no elevations present, the press platen possessed a tub structure. There were no deficiencies apparent in the transparency of the pressing. After the pressing, the structure depth/height difference between the cement joint and the tile print was determined on the boards.

| | Applied amount of | |
|---|---|---|
| | thickened melamine | Structure depth |
| Sample | resin in g/m² | in μm |
| 1 | 0 | 195 |
| 2 | 150 | 305 |
| 3 | 285 | 410 |

### Exemplary Embodiment 2—Overlay

On an impregnating channel, an overlay (paper weight: 25 g/m²) was impregnated in a first step with a melamine resin having a solids content of around 65% by weight. The overlay was intended for later pressing in a short-cycle press together with a tile decoration. In the edge region, the overlay possessed read marks at regular intervals for a scanner. The resin application rate was around 150 g liquid/m². Corundum in an amount of around 20 g/m² was scattered into the as yet undried resin using a scattering device. The grading according to FEPA standard was F200. Thereafter the impregnated assembly was dried back in a float dryer to a residual moisture content of around 15% by weight.

In this way, three overlays were prepared. In a further application, using a nozzle bar, a thickened melamine resin with a solids content of 70% by weight was applied to two overlays. An amount of 150 g/m² was applied to one overlay, and an amount of 285 g/m² to a further overlay. This application took place in those regions of the overlay intended for subsequent location on the regions of the tile print, but not in the regions of the cement joint print. The information for controlling the nozzles came from the digital printing data for the decorative print. Precise positioning took place using the markings at the edge of the overlay. Here, the distance between the marks in transverse direction was ascertained as well as that in longitudinal direction. The resin was thereafter dried, using a further float dryer, so that the resin moisture content was around 6% by weight. The overlays were subsequently separated into sheet product by means of a clipper.

The three overlays were then placed, with a decorative impregnated assembly (tile decoration), which was likewise provided with marks at regular intervals in the edge region, onto HDF boards. These HDF boards served as carrier material. The precise positioning of the overlay on the decorative impregnated assembly, and the positioning of the construction in the press, were carried out with a camera system. In order to ensure stress symmetry, a backing in the form of an impregnated assembly was located on the bottom side of the HDF boards. For the pressing, a press platen with a tile structure was installed in the SC press. The construction was pressed in the SC press at a temperature of around 200° C., a pressure of around 40 kg/cm² and a pressing time of around 15 seconds. After the pressing of the three different overlays, the structure depth was determined in each case.

| | Applied amount of | |
|---|---|---|
| | thickened melamine | Structure depth |
| Sample | resin in g/m² | in μm |
| 1 | 0 | 150 |
| 2 | 150 | 230 |
| 3 | 280 | 330 |

### LIST OF REFERENCE SYMBOLS

10 Carrier material
20 Resin layer
30 Press platen
31 Structure of the press platen
40 Overlay

1. A method for applying a decoration and a surface structure to a carrier material, comprising the following steps:
providing a carrier material or a carrier material, at least one decorative paper and at least one overlay;
printing the carrier material or the at least one decorative paper with a decoration;
producing a file for the surface structure, containing the digital data of the surface structure of the decoration, from the digital image data of the decoration;
applying at least one layer of resin to the printed carrier material or to at least one overlay, the distribution of the resin being dictated by the digital data of the file for the surface structure and thus being dependent on the imprinted decoration;
pressing the at least one resin layer with the carrier material using a structured press platen or pressing the at least one overlay, the at least one decorative paper and a carrier material using a structured press platen, the structure of the press platen being dictated by the digital data of the file for the surface structure and thus being dependent on the printed decoration;
where a surface structure is formed on the carrier material that is synchronous to the applied decoration; and
where a part of the structure height of the surface structure results from the application of the at least one resin layer.

2. The method as claimed in claim 1, wherein, at least in portions, a surface structure having a structure depth of more than 200 μm, preferably more than 300 μm, particularly preferably more than 400 μm is formed.

3. The method as claimed in claim 1, wherein multiple layers of resin are applied to the printed carrier material or to the overlay.

4. The method as claimed in claim 1, wherein pulverulent and/or liquid resin is applied.

5. The method as claimed in claim 1, wherein the resin is selected from the group containing melamine-formaldehyde resins, phenolic resins, melamine-urea-formaldehyde resins and urea-formaldehyde resins.

6. The method as claimed in claim 1, wherein the liquid resin is applied with a solids content of more than 70%.

7. The method as claimed in claim 1, wherein the resin comprises at least one additive and/or adjuvants.

8. The method as claimed in claim 7, wherein the at least one additive is selected from the group containing curing agent, wetting agent and release agent and/or the at least one adjuvant is selected from the group containing conductive substances and cellulose.

9. The method as claimed in claim 1, wherein between 100 and 500 g/cm² of resin are applied.

10. The method as claimed in claim 1, wherein an undercoat is applied to the carrier material.

11. The method as claimed in claim 1, wherein after the application of a layer of resin it is incipiently dried or set.

12. The method as claimed in claim 1, wherein in the pressing of the at least one resin layer with the carrier material using a press platen or the pressing of the at least one overlay, the at least one decorative paper and a carrier material using a press platen is carried out in an SC press (short-cycle press).

13. The method as claimed in claim 1, wherein the carrier material is selected from the group containing wood-based material boards, more particularly medium-density fiberboard (MDF), high-density fiberboard (HDF), chipboard, oriented-strand board (OSB), plywood boards and wood-plastic composite (WPC) boards.

14. An apparatus for applying a decoration and a surface structure to a carrier material by a method according to claim 1, comprising
optionally at least one application apparatus for applying at least one undercoat layer;
optionally at least one application apparatus for applying at least one primer layer;
at least one printing apparatus;
at least one camera system for positioning of a structured press platen and the carrier material or a structured press platen, a decorative paper, an overlay and the carrier material;
a means for producing a file for the surface structure from the digital image data of the decoration;
at least one application apparatus for applying the at least one resin layer, the application apparatus comprising a computing unit or being connected to a computing unit which comprises computer software which controls the amount of resin applied as a function of location;
optionally an application apparatus for applying corundum and/or glass beads;
optionally an apparatus for incipiently drying an applied resin layer;
a means for pressing the at least one resin layer with the carrier material or for pressing the overlay and the decorative paper with a carrier material using a structured press platen; and
wherein the structured press platen has a structure dictated by the digital data of the file for the surface structure.
